(19) United States
(12) Patent Application Publication
(10) Pub. No.: US 2011/0277708 A1
(43) Pub. Date: Nov. 17, 2011

(54) Cylinder Head for Internal Combustion Engine

(75) Inventors: Brian W. Geiser, Ortonville, MI (US); Rodney E. Baker, Fenton, MI (US)

(73) Assignee: GM GLOBAL TECHNOLOGY OPERATIONS, INC., Detroit, MI (US)

(21) Appl. No.: 12/888,080

(22) Filed: Sep. 22, 2010

Related U.S. Application Data
(60) Provisional application No. 61/345,361, filed on May 17, 2010.

(51) Int. Cl. F02F 1/40

(52) U.S. Cl. 123/41.82 R

(57) ABSTRACT

A cylinder head for an internal combustion engine comprises a cooling water jacket having a high volume lower portion and a low volume upper portion. A plurality of coolant risers in the high volume lower portion are configured to receive high pressure coolant from coolant openings in a cylinder block. Coolant risers extending between the high volume lower portion and low volume upper portion define restrictions regulate coolant flow from the high volume lower portion to the low volume upper portion at a predetermined volume and flow.

### CROSS-REFERENCES TO RELATED APPLICATIONS

This patent application claims priority to U.S. Provisional Patent Application Ser. No. 61/345,361 filed May 17, 2010 which is hereby incorporated herein by reference in its entirety.

### FIELD OF THE INVENTION

Exemplary embodiments of the present invention relate to cylinder heads for internal combustion engines and, more particularly, to a cylinder head having a multi-zone water jacket for directed and/or customized cooling thereof.

### BACKGROUND

With the increased focus on vehicle economy, particularly vehicle fuel economy, automotive manufacturers are turning to alternative, advanced powertrain designs to improve performance and to boost efficiency. One such design integrates the engine exhaust manifold into the cylinder head (“IEM”). Such an integrated design reduces heat loss from the exhaust gases which may improve turbocharger performance as well as the performance of exhaust after treatment devices. A reduction in the overall size of the engine allows packaging in a smaller vehicle.

IEM's may present special cooling needs due to higher temperatures brought about by the containment of the exhaust gas in the cylinder head. More particularly, temperatures in the lower portion of the cylinder head which are closer to the cylinder block deck are higher than in the upper portion of the cylinder head and may require higher levels of heat removal and, thus, larger volumes of coolant flow.

Other alternative powertrain designs such as cylinder direct injection of fuel may require that the fuel injectors and the spark plugs be placed centrally at the top of the combustion chamber in the upper portion of the cylinder head. While in a portion of the cylinder head that typically required a lower level of heat removal, the proximate placement of the fuel injectors with the spark plugs may result in a reduced area for the flow of coolant thereby increasing required levels of heat removal and, thus, larger volumes of coolant flow.

It is, therefore, desirable to provide a cylinder head that has a water jacket providing cooling characteristics that may be tailored to address the varying cooling needs of an advanced cylinder head such as an IEM cylinder head.

### SUMMARY

In an exemplary embodiment a cylinder head assembly for an internal combustion engine comprises a cooling water jacket comprising a lower portion and an upper portion, a plurality of coolant risers in the lower portion configured to receive high pressure coolant through coolant openings in a cylinder head deck and coolant risers extending between the lower portion and the upper portion defining restrictions of varying size to regulate coolant flow from the lower portion to the upper portion at a predetermined volume and flow.

In another exemplary embodiment, a cooling water core for defining a cooling water jacket in a cylinder head for an internal combustion engine comprises a high volume lower portion and a low volume upper portion, a plurality of coolant risers in the high volume lower portion configured to define high pressure coolant inlets to receive coolant, and coolant risers extending between the high volume lower portion and low volume upper portion configured to define restrictions of varying size to regulate coolant flow from the high volume lower portion to the low volume upper portion of the cooling water jacket at a predetermined volume and flow.

The above features and advantages, and other features and advantages of the present invention are readily apparent from the following detailed description of the invention when taken in connection with the accompanying drawings.

### BRIEF DESCRIPTION OF THE DRAWINGS

Other objects, features, advantages and details appear, by way of example only, in the following detailed description of the embodiments, the detailed description referring to the drawings in which:

FIG. 1 is a top view of a cylinder head embodying features of the present invention;

FIG. 2 is a bottom view of the cylinder of FIG. 1;

FIG. 3 is a perspective view of a cooling water jacket core embodying features of the present invention;

FIG. 4 is a sectional view taken along Line 4-4 of the cylinder head of FIG. 1;

FIG. 5 is a sectional view taken along Line 5-5 of the cylinder head of FIG. 1;

FIG. 6 is a sectional view taken along Line 6-6 of the cylinder head of FIG. 1;

FIG. 7 is a top view of a cooling water jacket core embodying features of the present invention;

FIG. 8 is a partial bottom perspective view of a cooling water jacket core embodying features of the present invention; and

FIG. 9 is a sectional view taken along Line 9-9 of the cylinder head of FIG. 2.

### DESCRIPTION OF THE EMBODIMENTS

The following description is merely exemplary in nature and is not intended to limit the present disclosure, application or uses. It should be understood that throughout the drawings, corresponding reference numerals indicate like or corresponding parts and features.

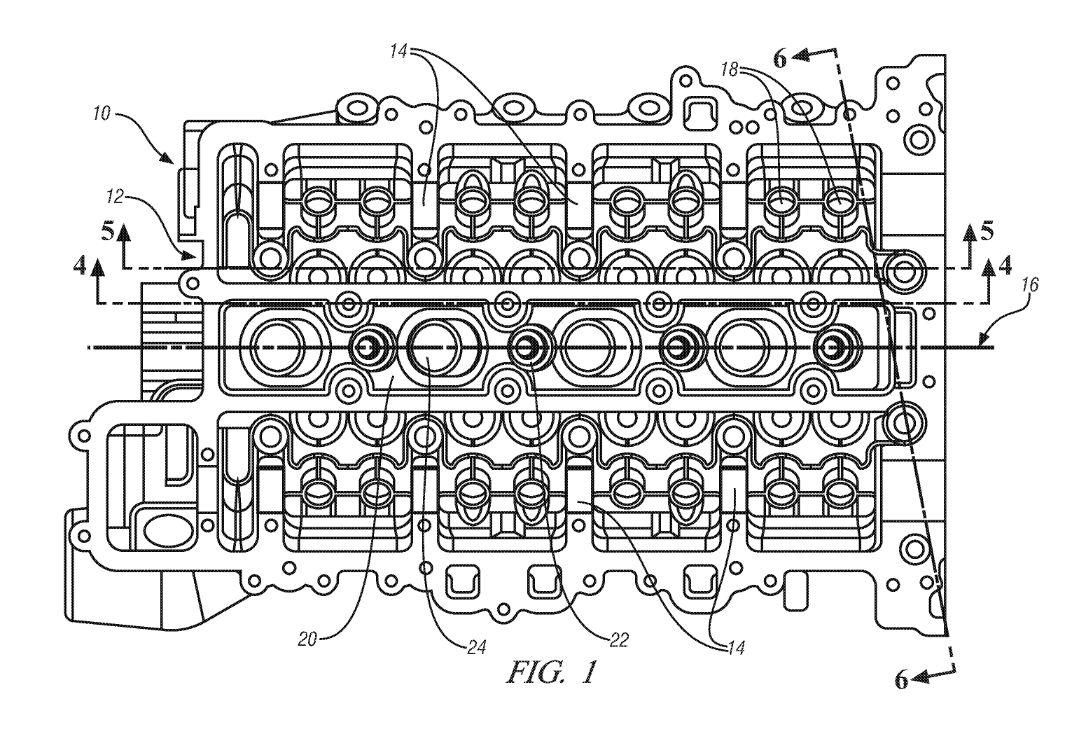

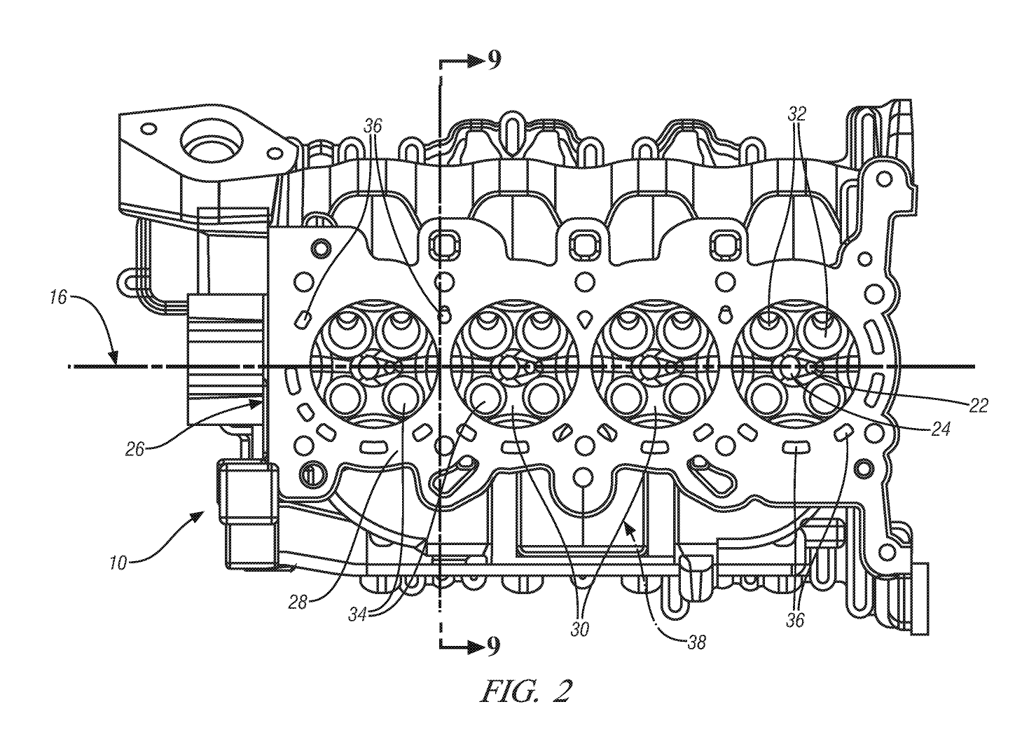

Referring now to FIGS. 1 and 2, an exemplary embodiment of the invention is directed to a cylinder head assembly 10 for application to an internal combustion engine (not shown). The cylinder head includes an upper portion 12 including a plurality of rows of camshaft supports 14 extending, in parallel, along the axis 16 thereof. The camshafts (not shown) operate on the distal ends of valve lifters (not shown) which extend to the lash adjuster openings 18 in the upper portion 12 of the cylinder head assembly 10. An axially extending valley 20 extends between and in parallel to the camshaft supports and includes a plurality of fuel injector ports 22 and spark plug ports 24 disposed therein.

A lower portion 26, FIG. 2, of the cylinder head assembly 10 comprises a cylinder head deck 28 that is configured to sealingly mate with an upper deck of a cylinder block (not shown). The cylinder head deck 28 includes a plurality of combustion chambers 30 opening therethrough. Each combustion chamber 30 has one or more intake openings 32 and exhaust openings 34 configured for the inlet and egress of combustion air and combustion gases therefrom. In the embodiment shown in the FIG. 2, fuel injector ports 22 and spark plug ports 24 open into each combustion chamber 30. In other embodiments, the fuel injectors may be located upstream of the combustion chamber 30 thereby eliminating the need for fuel injector ports 22 in the combustion chamber. Coolant openings 36 located about the cylinder head deck 28 provide for the flow of engine coolant from the cylinder block to the cylinder head assembly 10 for the removal of excess heat therefrom.

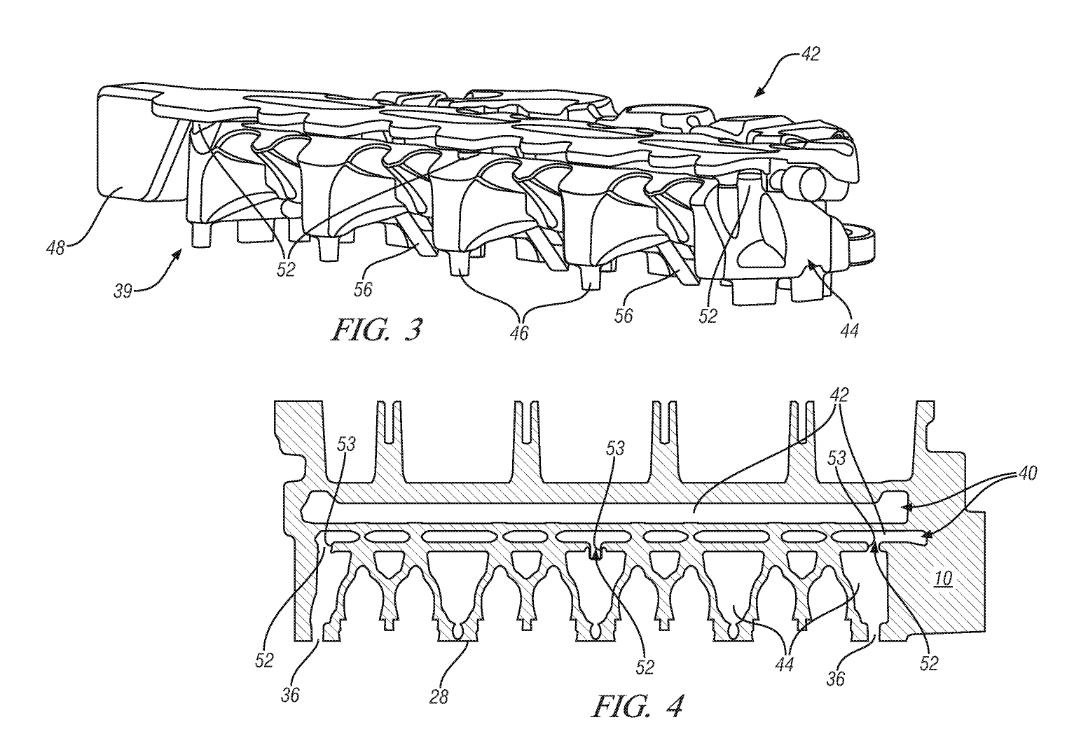

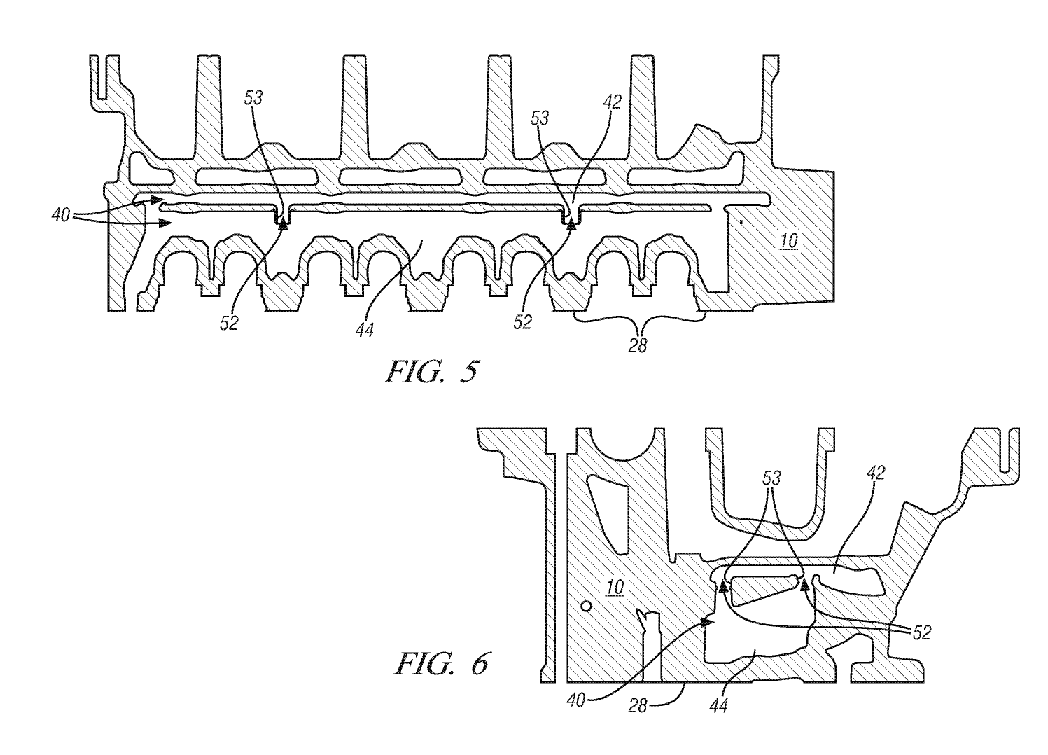

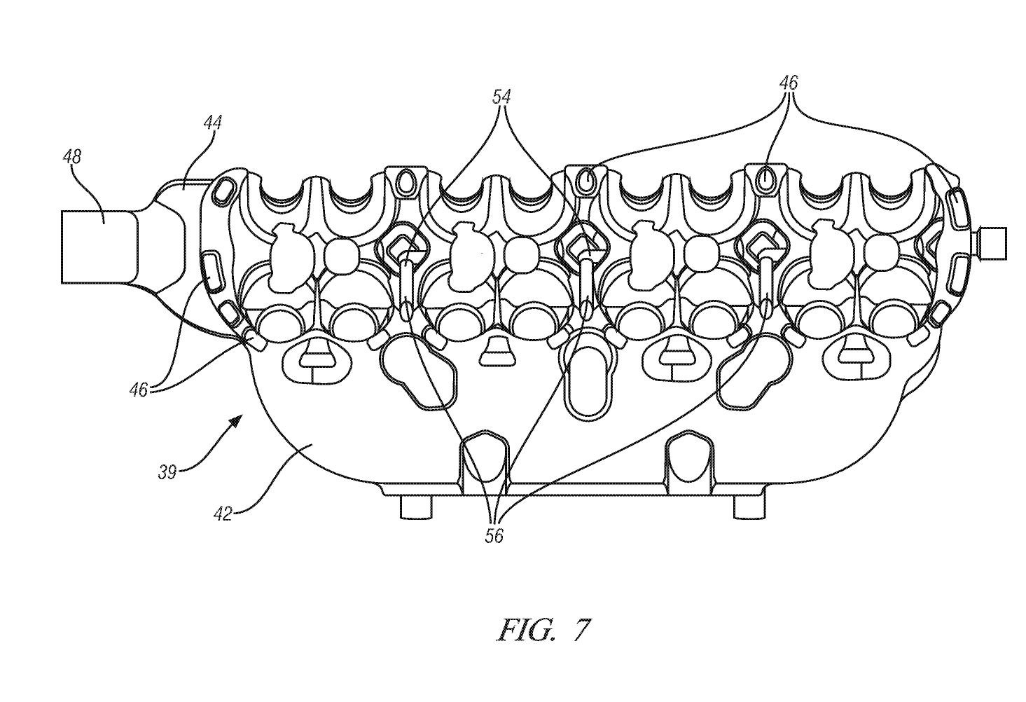

The cylinder head assembly 10 includes an integral exhaust manifold (“IEM”) 38 that is cast in the cylinder head lower portion 26. As a result of heat from the exhaust gas flowing through the IEM 38, significant cooling is required to remove excess heat from the locations surrounding the IEM. In an exemplary embodiment of the cylinder head assembly 10, FIGS. 3, 7 and 8, illustrate the core 39 of a cooling water jacket 40, FIGS. 4, 5, 6 and 9, that is effective at managing the thermal loads produced by the IEM 38 and other features thereof. For purposes of clarity, the features of the cooling water jacket 40 and the core 39, that is utilized to form the cooling water jacket during casting of the cylinder head assembly 10, will be similarly described so that the operation of the cooling system of the cylinder head assembly 10 will be clearly understood.

In an exemplary embodiment, the core 39 of the cooling water jacket 40 comprises an upper portion 42 and a lower portion 44. The lower portion 44 of the cooling water jacket 40 includes a series of coolant risers 46 that are configured to receive high pressure coolant from coolant openings in the cylinder block (not shown). The number of and diameter of coolant risers 46 that extend between the engine cylinder block and the lower portion 44 of the cooling water jacket 40 result in a high volume and flow of coolant to address the cooling requirements of the IEM 38 as well as the thermal requirements around the combustion chambers 30, which can include the highest temperatures experienced by the cylinder head assembly 10. Following removal of excess heat from these areas, the coolant is removed from the cylinder head assembly 10 through a coolant outlet 48 and is circulated through a suitable cooler such as a radiator or heat exchanger (not shown).

The upper portion 42 of the cooling water jacket 40 includes a series of coolant risers 52 that are configured to receive pressurized coolant from lower portion 44 of the cooling water jacket 40. The coolant risers 52 define restrictions 53, FIG. 4. The number of, and diameter of coolant risers 52 that extend between the lower portion 44 of the cooling water jacket 40 and the upper portion 42 are configured to result in predetermined volumes and flows of coolant to address the various cooling requirements of the upper portion 42. As illustrated in FIGS. 4 and 5, the upper to lower touch points or connectors defining the coolant risers 52, at which the upper portion 42 and the lower portion 44 of the cooling water jacket interface, are varied along its length and operate as restrictions to individually vary the flow of coolant from the lower to upper portions. Following removal of excess heat from these areas, the coolant is removed from the cylinder head assembly 10 through a coolant outlet 48 and is circulated through a suitable cooler such as a radiator or heat exchanger (not shown).

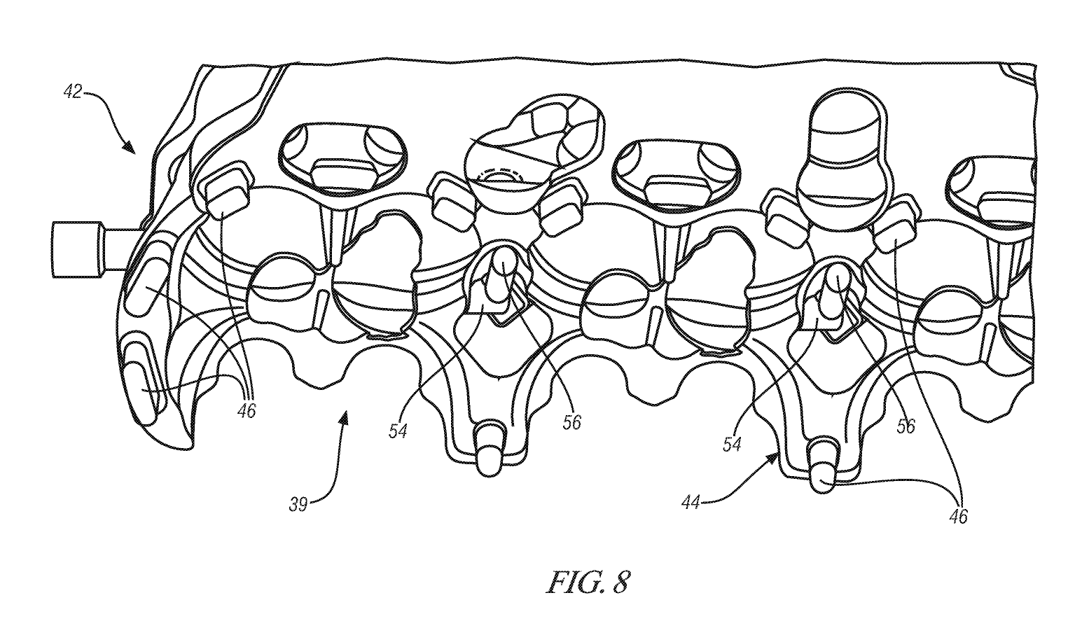

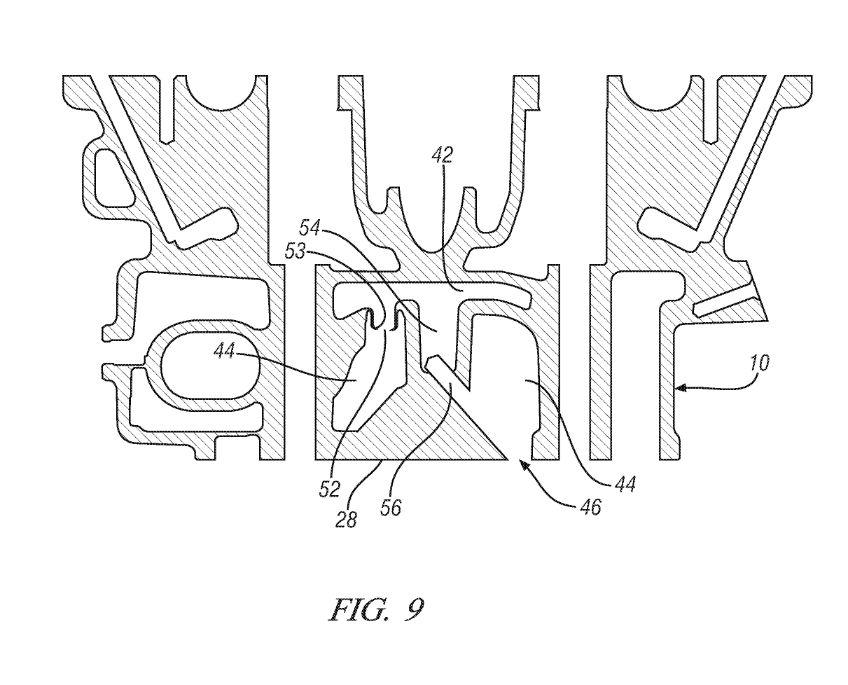

Drilled cooling jets 56 FIGS. 3, 7, 8 and 9, extend between the cylinder block deck to cooling passages 54 adjacent the fuel injector ports 22 and the spark plug ports 24, which, due to the restricted area around these features may require a higher coolant flow velocity and volume for adequate heat removal. Utilizing the higher pressure differential between the cylinder block deck and the cooling passages 54, a significantly higher coolant flow velocity is established through the cooling passages 54 resulting in targeted heat removal from around the fuel injector ports 22 and the spark plug ports 24. The cooling jets may extend from the cylinder block deck to the cooling passages 54 located in the lower portion 44 of the cooling water jacket 40, FIG. 8 or, in an alternative embodiment, may extend from the cylinder block deck to the cooling passages 54 located in the upper portion 42 of the cooling water jacket 40, FIG. 9. Positioning the cooling passages 54 in the upper portion 42 of the cooling water jacket will take advantage of the significantly higher pressure differential between the coolant in the cylinder block deck and the coolant in the upper portion 42 of the cooling water jacket 40. A higher coolant flow velocity through the cooling passages 54 results in a significant increase in heat removal from around the fuel injector ports 22 and the spark plug ports 24.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. A cylinder head assembly for an internal combustion engine comprising:
a cooling water jacket comprising a lower portion and an upper portion;
a plurality of coolant risers in the lower portion configured to receive high pressure coolant through coolant openings in a cylinder head deck; and
coolant risers extending between the lower portion and the upper portion defining restrictions of varying size to regulate coolant flow from the lower portion to the upper portion at a predetermined volume and flow.

2. The cylinder head of claim 1, wherein the restrictions vary in size along a length of the cooling water jacket and are configured to individually vary the flow of coolant from the lower portion to the upper portion.

3. The cylinder head of claim 1, further comprising:
drilled cooling jets extending between the cylinder head deck and cooling passages adjacent fuel injector ports, spark plug ports or both in the lower portion of the cooling water jacket to direct a targeted coolant flow therethrough.

4. The cylinder head of claim 1, further comprising:
drilled cooling jets extending between the cylinder head deck and cooling passages adjacent fuel injector ports, spark plug ports or both in the upper portion of the cooling water jacket configured to utilize a pressure differential between the cylinder head deck and the cooling passages adjacent fuel injector ports, spark plug ports or both of the cylinder head to direct a targeted coolant flow therethrough.

5. A cooling water core for defining a cooling water jacket in a cylinder head for an internal combustion engine comprising:
a high volume lower portion and a low volume upper portion;
a plurality of coolant risers in the high volume lower portion configured to define high pressure coolant inlets to receive coolant; and
coolant risers extending between the high volume lower portion and low volume upper portion configured to define restrictions of varying size to regulate coolant flow from the high volume lower portion to the low volume upper portion of the cooling water jacket at a predetermined volume and flow.

6. The cooling water core of claim 5, wherein the restrictions vary in size along a length of the cooling water jacket to individually vary the flow of coolant from the lower portion to the upper portion.

7. The cooling water core of claim 5, further comprising:
drilled cooling jets connecting to cooling passages adjacent fuel injector ports, spark plug ports or both in the lower portion of the cooling water jacket to direct a targeted coolant flow therethrough.

8. The cooling water core of claim 5, further comprising:
drilled cooling jets extending between the high volume lower portion and cooling passages adjacent fuel injector ports, spark plug ports or both in the low volume upper portion of the cooling water jacket configured to utilize a pressure differential between the high volume lower portion and the cooling passages adjacent fuel injector ports, spark plug ports or both of the cylinder head to direct a targeted coolant flow therethrough.
